(19) United States
(12) Patent Application Publication
(10) Pub. No.: US 2024/0246548 A1
(43) Pub. Date: Jul. 25, 2024

(54) INFORMATION PROCESSING DEVICE, OBJECT TRACKING DEVICE, TRACKING METHOD, AND STORAGE MEDIUM

(71) Applicant: DENSO CORPORATION, Kariya-city (JP)

(72) Inventors: Yusuke AKAMINE, Nisshin-city (JP); Takuya TAKAYAMA, Kariya-city (JP)

(21) Appl. No.: 18/628,499

(22) Filed: Apr. 5, 2024

Related U.S. Application Data
(63) Continuation of application No. PCT/JP2022/036528, filed on Sep. 29, 2022.

(30) Foreign Application Priority Data
Oct. 7, 2021 (JP) 2021-165684

(51) Int. Cl. B60W 50/029; B60W 50/02; G01S 7/41; G01S 13/56

(52) U.S. Cl. CPC B60W 50/029; B60W 50/0205; G01S 7/415; G01S 13/56; B60W 2420/408; B60W 2520/10; B60W 2554/20; B60W 2556/10

(57) ABSTRACT

An information processing device for a vehicle includes an observed value detection unit, a tracking unit, and an abnormality determination unit. The abnormality determination unit determines whether a vehicle speed abnormality has occurred. If it is determined that no vehicle speed abnormality has occurred, the tracking unit performs a first process using a predicted value of a relative speed based on a detection result of a vehicle speed to calculate a current estimated value. If it is determined that the vehicle speed abnormality has occurred, the tracking unit performs a second process different from the first process to calculate the current estimated value.

### CROSS-REFERENCE TO RELATED APPLICATION

The present application is based on and claims the benefit of priority from earlier Japanese Patent Application No. 2021-165684 filed on Oct. 7, 2021, the description of which is incorporated herein by reference.

### BACKGROUND

### Technical Field

The present disclosure relates to an information processing device for tracking an object, an object tracking device, a tracking method, and a storage medium.

### Related Art

When an object around an own vehicle is recognized by an in-vehicle radar device, estimating a state of the object using a result (hereinafter, also referred to as an observed value) obtained by subjecting an observation signal acquired from the in-vehicle radar device to a frequency analysis is repeatedly performed at predetermined processing cycles. That is, a technique is known which tracks an object by estimating a state of an object in time series.

### SUMMARY

An aspect of the present disclosure provides an information processing device for a vehicle, the device including: an observed value detection unit configured to acquire an observation signal output from a sensor transmitting and receiving radar waves and detect, from the observation signal, at least one observed value related to at least one target around the vehicle; a tracking unit configured to track the target by calculating a current predicted value from a past estimated value which indicates a state of the target and calculating a current estimated value from a current observed value and the current predicted value at predetermined processing cycles; and an abnormality determination unit configured to determine whether a vehicle speed abnormality has occurred. If it is determined that no vehicle speed abnormality has occurred, the tracking unit performs a first process using the predicted value of a relative speed based on a detection result of a vehicle speed to calculate the current estimated value. If it is determined that the vehicle speed abnormality has occurred, the tracking unit performs a second process different from the first process to calculate the current estimated value.

### BRIEF DESCRIPTION OF THE DRAWINGS

In the accompanying drawings:

FIG. 1 is a block diagram illustrating a configuration of an object tracking device including an information processing device of a first embodiment;

FIG. 2 is an explanatory drawing illustrating an example of a detection area in a case in which a radar device is mounted on the front of an own vehicle;

FIG. 3 is an explanatory drawing illustrating an example of detection areas in a case in which the radar devices are mounted also at locations other than the front of the own vehicle;

FIG. 4 is a block diagram functionally illustrating a configuration of the information processing device;

FIG. 5 is a flowchart of a tracking process;

FIG. 6 is a flowchart of a prediction process;

FIG. 7 is a flowchart of an association process;

FIG. 8 is an explanatory drawing illustrating an example of determination of an observed value associated with a predicted value and calculation of an estimated value;

FIG. 9 is an explanatory drawing illustrating another example of determination of an observed value associated with a predicted value and calculation of an estimated value;

FIG. 10 is a flowchart of an estimation process;

FIG. 11 is a flowchart of a vehicle speed abnormality detection process;

FIG. 12 is a flowchart of a stationary object prediction residual process;

FIG. 13 is a flowchart of a prediction process of a second embodiment; and

FIG. 14 is an explanatory drawing illustrating a process in which a current estimated value of an object is calculated from a previous estimated value of the object when a position of the object is used as the estimated value according to another embodiment.

### DETAILED DESCRIPTION OF THE PREFERRED EMBODIMENTS

When an object around an own vehicle is recognized by an in-vehicle radar device, estimating a state of the object using a result (hereinafter, also referred to as an observed value) obtained by subjecting an observation signal acquired from the in-vehicle radar device to a frequency analysis is repeatedly performed at predetermined processing cycles. That is, a technique is known which tracks an object by estimating a state of an object in time series.

As the observed value, a distance, an azimuth, and a relative speed may be used. For example, JP 2018-25492 A describes a technique that tracks an object with high accuracy using a distance, an azimuth, and a relative speed as observed values.

According to the technique that tracks an object, for example, regarding the relative speed, the distance, the azimuth, and the like described above, the observed value and a predicted value are associated with each other, and an estimated value indicating a current state of each object is calculated based on the associated observed value and predicted value.

For example, when a predicted value of a relative speed is calculated, it can be considered to use a method of calculating the predicted value of a relative speed based on an own vehicle speed. In this case, for example, if the own vehicle speed changes between a previous processing cycle and a current processing cycle (i.e., between earlier and later processing cycles), the predicted value of a relative speed can be accurately calculated as a value depending on the change of the own vehicle speed. For example, if the amount of change of the own vehicle speed is 1 km/hour between earlier and later processing cycles, there is a problem that the amount of change of the own vehicle speed (i.e., 1 km/hour) is reflected in the magnitude of the predicted value of a relative speed at the current processing cycle.

Hence, it can be considered that a predicted value of a relative speed, and furthermore an estimated value of a relative speed, can be accurately calculated. As a result, accuracy in tracking an object (e.g., accuracy regarding an estimated value of a position of the object based on the relative speed, an estimated value of a ground speed of the object based on the relative speed, or the like) increases.

However, for example, a case is excluded in which a state has occurred in which an own vehicle speed differs from an actual speed of the moving own vehicle (hereinafter, also referred to as a vehicle speed abnormality) due to slipping or the like of the wheels. This is because, in the above method of calculating a predicted value of a relative speed based on an own vehicle speed, an error in the predicted value of a relative speed may increase due to a large error in the own vehicle speed.

That is, when no vehicle speed abnormality has occurred, a current estimated value of an object can be accurately calculated using an accurate predicted of a relative speed. However, when a vehicle speed abnormality has occurred, since accuracy of the predicted value of a relative speed decreases, accuracy of the current estimated value of the object decreases. As a result, when a vehicle speed abnormality has occurred, accuracy in tracking the object may decrease.

An aspect of the present disclosure provides a technique for accurately tracking an object when no vehicle speed abnormality has occurred and suppressing accuracy in tracking the object from lowering when a vehicle speed abnormality has been detected.

Hereinafter, embodiments of the present disclosure will be described with reference to the drawings.

### 1. First Embodiment

### 1. Overall Configuration

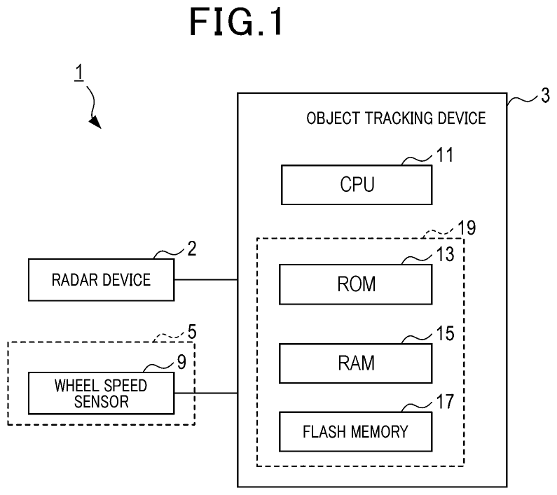

A configuration of an object tracking device 1 will be described with reference to FIG. 1. The object tracking device 1 is installed in a vehicle (hereinafter, also referred to as an own vehicle JV) and includes a radar device 2, an information processing device 3, and a detection unit 5.

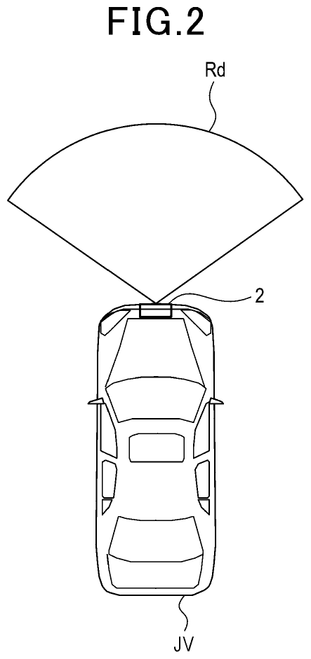

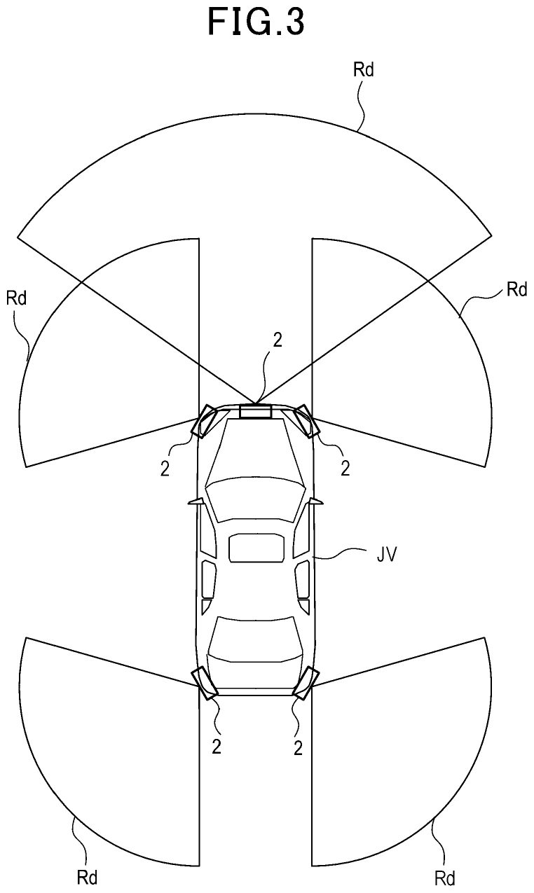

As illustrated in FIG. 2, the radar device 2 may be mounted on the center of the front of the own vehicle JV (e.g., the center of a front bumper) and use an area around the own vehicle JV, specifically, an area on the center of the front of the own vehicle JV as a detection area Rd. In addition, as illustrated in FIG. 3, the radar devices 2 may be respectively mounted on the lateral left front and the lateral right front (e.g., the left end and the right end of the front bumper) of the own vehicle JV and use areas around the own vehicle JV, specifically, areas on the left front and the right front of the own vehicle JV respectively as detection areas Rd.

In addition, the radar devices 2 may be respectively mounted on the lateral left rear and the lateral right rear (e.g., the left end and the right end of the rear bumper) of the own vehicle JV and use areas around the own vehicle JV, specifically, areas on the left rear and the right rear of the own vehicle JV respectively as detection areas Rd. The number and mounting positions of the radar devices 2 mounted to the own vehicle JV may be appropriately selected.

The radar device 2 is a millimeter-wave radar and transmits and receives radio waves. The radar device 2 includes a transmission array antenna configured by a plurality of antenna elements and a reception array antenna configured by a plurality of antenna elements. The radar device 2 irradiates the detection areas Rd with transmission waves at processing cycles arriving at a predetermined period Tcy.

Then, the radar device 2 receives reflected waves (i.e., reception waves) that are transmission waves reflected at reflection points of a target. It is noted that the target is an object such as a vehicle, a road surface, a roadside object, or the like. Furthermore, the radar device 2 generates a beat signal that is a mixture of the transmission waves and the reception waves and outputs a signal generated by sampling the beat signal to the information processing device 3.

The signal output from the radar device 2 is referred to as an observation signal. It is noted that, here, although a signal generated by sampling a beat signal is output as an observation signal, the present disclosure is not limited to this. It is noted that, here, although the radar device 2 uses an FMCW system, the present disclosure is not limited to this. Any modulation, for example, multiple frequency CW and FCM may be used. FCM is an abbreviation for “Fast-Chirp Modulation”.

Returning to FIG. 1, the information processing device 3 is mainly configured by a well-known microcomputer having a CPU 11, a ROM 13, a RAM 15, a flash memory 17, and the like. The CPU 11 executes a program stored in the ROM 13 to implement various functions. Executing the program performs a method corresponding to the program.

It is noted that a memory 19 such as the ROM 13, the RAM 15, the flash memory 17, and the like is a non-transitory tangible storage medium. In addition, the information processing device 3 may include a coprocessor that performs a fast Fourier transformation processing (i.e., FFT processing) and the like. The information processing device 3 may be configured by one or a plurality of microcomputers. The various functions of the information processing device 3 may be implemented not only by using software. Part or all of elements of the functions may be implemented by using one or a plurality of hardware components. For example, when the functions are implemented by an electronic circuit, which is hardware, the electronic circuit may be implemented by a digital circuit including a number of logic circuits, an analog circuit, or a combination thereof.

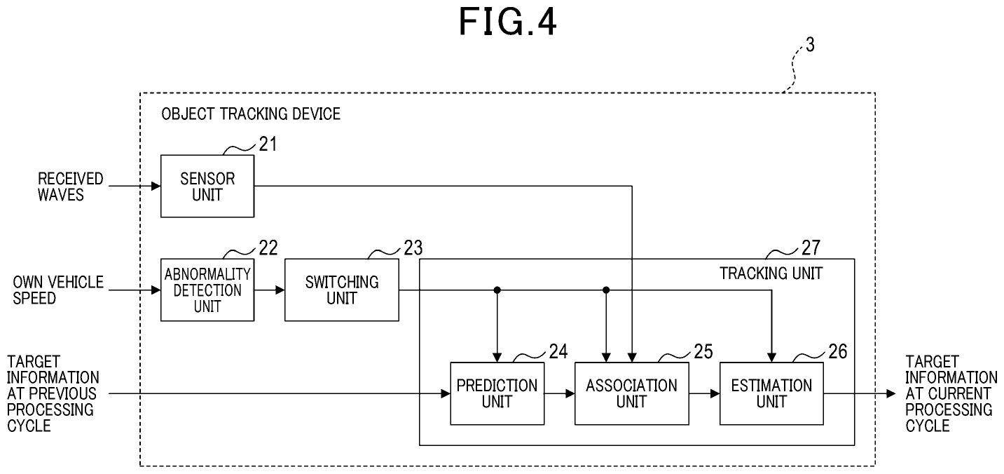

In the information processing device 3, the CPU 11 executes the program, specifically, as illustrated by solid lines in FIG. 4, to implement functions of a sensor unit 21, an abnormality detection unit 22, a switching unit 23, a prediction unit 24, an association unit 25, and an estimation unit 26 to perform a tracking process. It is noted that a tracking unit 27 described below includes the functions of the prediction unit 24, the association unit 25, and the estimation unit 26.

Although details will be described later, the information processing device 3 performs the tracking process based on an observation signal generated by the radar device 2 to estimate a state of a target at the current time.

To express a state of a target, for example, a distance from the own vehicle JV to the target, an azimuth of the target with respect to the own vehicle JV, and a relative speed of the target with respect to the own vehicle JV may be used. In addition, to express a state of a target, based on these, a position of the target with respect to the own vehicle JV calculated from a distance and an azimuth, and a ground speed of the target calculated from the relative speed of the target with respect to the own vehicle JV and a speed of the own vehicle JV (hereinafter, also referred to as an own vehicle speed) may be used eventually.

It is noted that, hereinafter, the distance from the own vehicle JV to the target, the azimuth of the target with respect to the own vehicle JV, and the relative speed of the target with respect to the own vehicle JV are also respectively referred to simply as a distance, an azimuth, and a relative speed.

The information processing device 3 may perform the tracking process to calculate, for example, estimated values of an azimuth, a distance, a relative speed and the like of the target at the present time to, based of these, calculate an estimated value of a position of the target and an estimated value of a ground speed of the target at the present time and output these to a driving assistance device or the like. Although not shown, the driving assistance device refers to various devices implementing driving assistance.

Returning to FIG. 1, the detection unit 5 includes various detection devices other than the radar device 2. As the detection device, at least wheel speed sensors 9 are included.

The wheel speed sensors 9 are provided to, for example, four wheels on four quarters of the own vehicle JV and output signals indicating rotational speeds of corresponding wheels (hereinafter, referred to as wheel speed signals). The wheel speed signals output from the respective wheel speed sensors 9 are input to the information processing device 3. As described later, the information processing device 3 can detect rotational speeds of the respective wheels based on the wheel speed signals output from the respective wheel speed sensors 9. Then, from the detection results, for example, it can be determined whether the wheels are slipping.

### 2. Process

### 2-1. Tracking Process

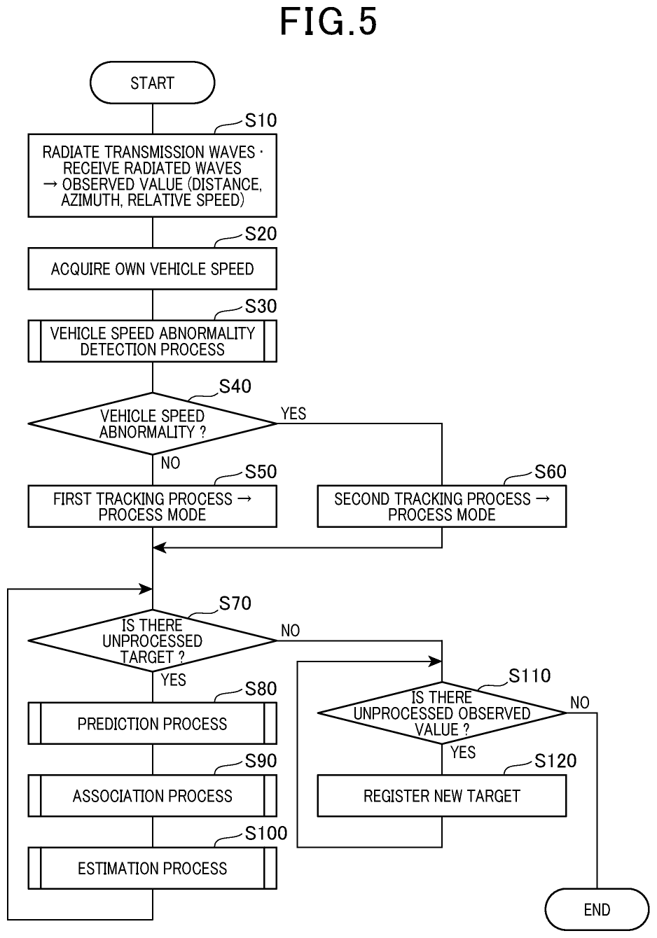

Next, a tracking process performed by the information processing device 3 of the first embodiment will be described with reference to a flowchart of FIG. 5. The information processing device 3 repeatedly performs the present tracking process at a predetermined period (i.e., period Tcy). A series of processing in steps S10 to S120 repeatedly performed at every period Tcy is also referred to as a processing cycle. The period Tcy may be, for example, several msec to several hundred msec.

First, in step S10, the sensor unit 21 detects observed values of targets present around the own vehicle JV. For example, in step S10, first, the sensor unit 21 causes the radar device 2 to radiate transmission waves. Subsequently, the sensor unit 21 acquires observation signals generated by the radar device 2 based on reflected waves received from reflection points. Then, the sensor unit 21 detects, from the observation signals acquired from the radar device 2, observed values at the present time (i.e., current processing cycle) of the targets present around the own vehicle JV.

For example, in step S10, as the observed values, a distance from the own vehicle JV to the target, an azimuth of the target with respect to the own vehicle JV, and a relative speed of the target with respect to the own vehicle JV are detected. It is noted that, for example, when the radar device 2 is configured to detect observed values of respective targets from the observation signals, the sensor unit 21 may be configured to acquire the observed values of the respective targets from the radar device 2.

Next, in step S20, the abnormality detection unit 22 detects an own vehicle speed from wheel speed signals acquired from the respective wheel speed sensors 9 and acquires the detected own vehicle speed as an observed value of the own vehicle speed at the current processing cycle. For example, the abnormality detection unit 22 may calculate an own vehicle speed based on an average value of rotational speeds of the respective wheels. It is noted that when an own vehicle speed is detected by a configuration other than the abnormality detection unit 22 (e.g., any of the wheel speed sensors 9, or another device), the abnormality detection unit 22 may be configured to acquire the detected own vehicle speed.

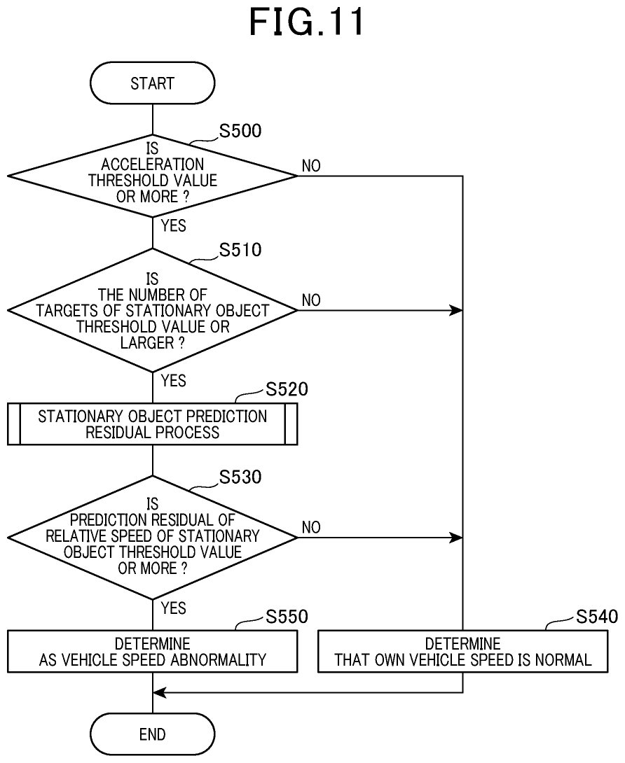

Subsequently, in S30, the abnormality detection unit 22 determines whether a vehicle speed abnormality has occurred. The vehicle speed abnormality indicates a state in which an abnormal vehicle speed of the own vehicle JV may be detected by the wheel speed sensor 9 (i.e., a state in which the detected own vehicle speed is not reliable). For example, a state in which the wheels of the own vehicle JV are slipping corresponds to the vehicle speed abnormality. It is noted that, hereinafter, the state in which the wheels of the own vehicle JV are slipping is also referred to as simply a state in which the own vehicle JV is slipping. Specifically, the abnormality detection unit 22 executes a subroutine illustrated in FIG. 11 (hereinafter, also referred to as a vehicle speed abnormality detection process). The vehicle speed abnormality detection process will be described later.

Next, in step S40, the switching unit 23 determines whether a vehicle speed abnormality has occurred based on the detection result of the abnormality detection unit 22 in step S30. If determining that no vehicle speed abnormality has occurred (i.e., a normal own vehicle speed has been detected), the switching unit 23 sets a first tracking process as a process performed by the information processing device 3 (hereinafter, also referred to as a process mode) in step S50, and shifts the present process to step S70. In contrast, if determining that a vehicle speed abnormality has occurred (i.e., no normal own vehicle speed has been detected), the switching unit 23 sets a second tracking process as the process mode in step S60, and shifts the present process to step S70.

In step S70, the tracking unit 27 determines whether there is unprocessed target information. The target information on each target is stored is stored in the memory 19. The target information indicates a past state of a target. That is, the target information includes a past estimated value. Specifically, the tracking unit 27 determines whether there is a target that has not been subjected to processing of the following steps S80 to S100. If determining that there is an unprocessed target in step S70, the tracking unit 27 shifts the present process to step S80 and performs processing of steps S80 to S100 for the selected target. In contrast, if determining that there is no unprocessed target, the tracking unit 27 shifts the present process to step S110.

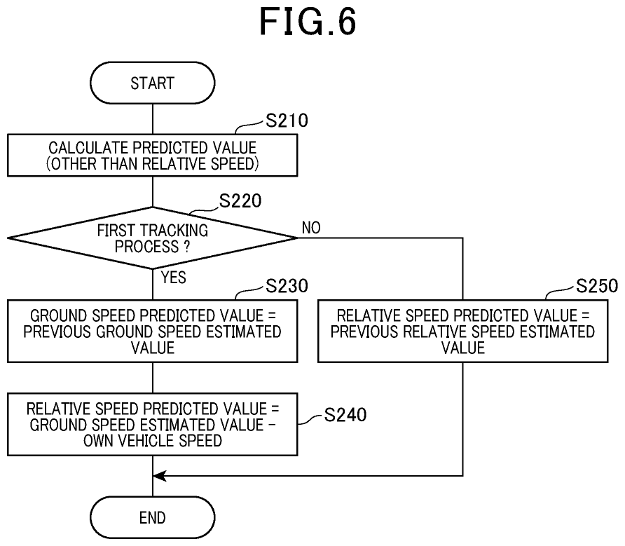

In step S80, the prediction unit 24 calculates, regarding one unprocessed target, a predicted value of the target at the present time based on the past estimated value of the target. For example, the past estimated value of the target refers to an estimated value of the target at the previous processing cycle. For example, the predicted value of the target at the present time refers to a predicted value of the target at the current processing cycle. The predicted value of the target includes a distance, an azimuth, and a relative speed as elements, as in the observed value. The predicted value of the target may include a ground speed of the target as an element. Specifically, the prediction unit 24 executes a subroutine illustrated in FIG. 6 (hereinafter, also referred to as a prediction process).

First, in S210, regarding the elements of the predicted value of the target other than a relative speed, the prediction unit 24 calculates a predicted value of the target at the current processing cycle (hereinafter, also referred to as simply current time) from the estimated value of the target at the previous processing cycle (hereinafter, also referred to as simply previous time). That is, regarding a distance of the target, a predicted value at the current time is calculated from the estimated value at the previous time. Regarding an azimuth, a predicted value at the current time is calculated from the estimated value at the previous time.

Next, in steps S220 to S250, regarding a relative speed of the target, the prediction unit 24 calculates a predicted value at the current time by a different manner depending on whether the process mode is the first tracking process, in other words, whether no vehicle speed abnormality has occurred or a vehicle speed abnormality has occurred.

Here, when the process mode is the first tracking process (i.e., no vehicle speed abnormality has occurred), in steps S230 to S240, a predicted value of a relative speed is calculated using the own vehicle speed detected in step S20.

Specifically, in S230, the prediction unit 24 calculates a predicted value of a ground speed of the target at the current process cycle from the estimated value of a ground speed of the target calculated at the previous process cycle. In the calculation, it is assumed that movement of the target is linear uniform motion during a short time period such as a time period from the previous processing cycle to the current processing cycle (i.e., period Tcy). Then, regarding the target, the previous estimated value of a ground speed is used as a current predicted value of a ground speed.

In succeeding step S240, regarding the target, the prediction unit 24 calculates a current predicted value of a relative speed. Specifically, regarding the target, based on the current predicted value of a ground speed and the own vehicle speed detected in step S20, the prediction unit 24 calculates the current predicted value of a ground speed of the target—the own vehicle speed as the current predicted value of a relative speed. Then, the prediction unit 24 terminates the present subroutine.

In contrast, when the process mode is the second tracking process (i.e., a vehicle speed abnormality has occurred), in step S250, a current predicted value of a relative speed is calculated without using the own vehicle speed detected in step S20. Specifically, it is assumed that movement of the own vehicle JV and the target is linear uniform motion during a short time period such as a time period from the previous processing cycle to the current processing cycle (i.e., period Tcy). Then, regarding the object, the current estimated value of a relative speed is used as a current predicted value of a relative speed. Then, the prediction unit 24 terminates the present subroutine.

Next, in step S90, regarding one of the unprocessed targets described above, the association unit 25 sets a predicted gate based on at least one element of the predicted value calculated in step S80. The predicted gate indicates a range in which it is estimated that a current observed value will be acquired. In the present embodiment, regarding three elements, that is, a distance, an azimuth, and a relative speed, the association unit 25 sets predicted gates.

Furthermore, the association unit 25 calculates an association cost. The association cost is an indicator indicating a degree of divergence between a predicted value and an observed value. In the present embodiment, the association cost indicates that as a value of the association cost is smaller, a relationship between the predicted value and the observed value is higher. In other words, the association cost indicates that as a value of the association cost is larger, the relationship between the predicted value and the observed value is lower.

Then, the association unit 25 determines the observed value whose association cost is the lowest among the observed values in the predicted gate, as an observed value associated with a predicted value.

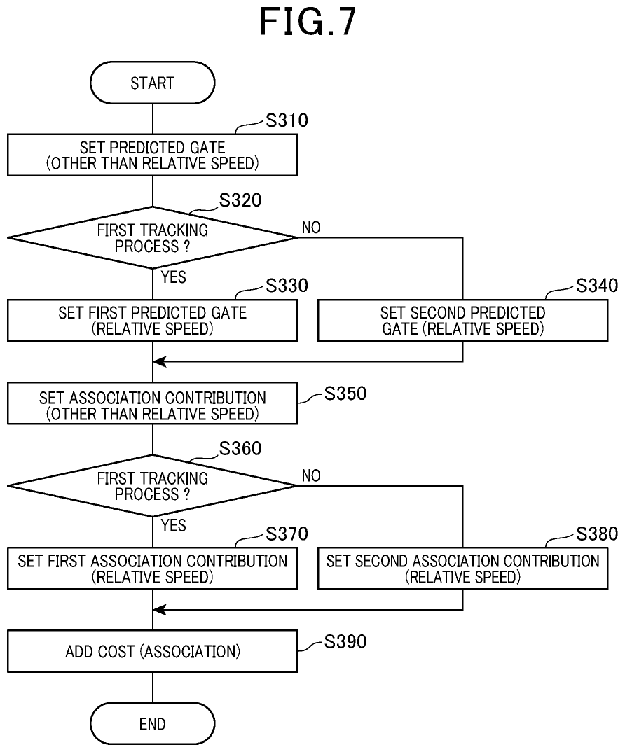

Specifically, the association unit 25 executes a subroutine (hereinafter, also referred to as an association process) illustrated in FIG. 7.

First, in step S310, the association unit 25 sets a predicted gate, which is a range in which it is estimated that an observed value will be acquired at the current processing cycle based on predicted values of elements other than a relative speed among the predicted values calculated in step S80 (i.e., a distance, an azimuth, and a relative speed).

The observed value detected from the same target having a predicted value should be a value close to the predicted value. Hence, centering on the predicted value calculated in step S80, the range of the observed value that is estimated to be detected from the same target having the predicted value is set as a predicted gate.

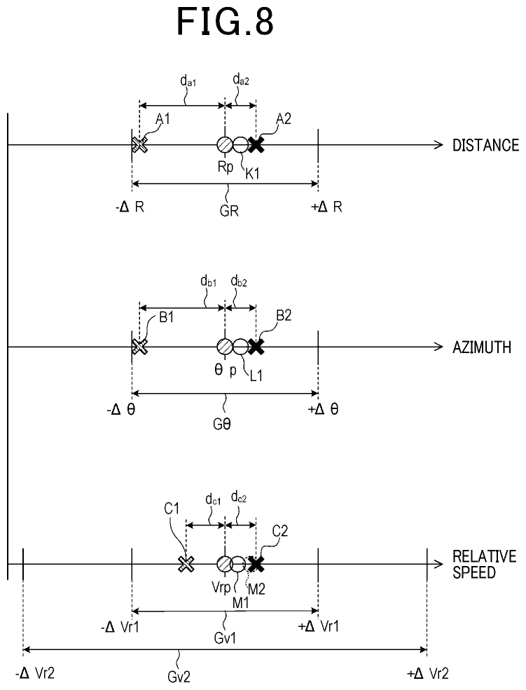

For example, as illustrated in FIG. 8, assuming that a predicted value Rp of a distance is calculated in step S80, for the predicted value Rp of a distance, the range of ±ΔR is set as a predicted gate of a distance (hereinafter, also referred to as a predicted gate GR).

In addition, for example, assuming that a predicted value θp of an azimuth is calculated in step S80, for the predicted value θp of an azimuth, the range of ±Δθ is set as a predicted gate of an azimuth (hereinafter, also referred to as a predicted gate Gθ).

Next, in steps S320 to S340, regarding a relative speed, the association unit 25 sets a predicted gate by a different manner depending on whether the process mode is the first tracking process, in other words, depending on whether no vehicle speed abnormality has occurred or a vehicle speed abnormality has occurred.

In step S320, the association unit 25 determines whether the process mode is the first tracking process. If determining that the process mode is the first tracking process, the association unit 25 shifts the present process to step S330. If determining that the process mode is the second tracking process, the association unit 25 shifts the present process to step S340.

Here, if the process mode is the first tracking process (i.e., no vehicle speed abnormality has occurred), in steps S330, centering on the predicted value of a relative speed calculated in step S80, the association unit 25 sets the range of the observed value of a relative speed which is estimated to be detected from the same target having the predicted value of a relative speed, as a predicted gate. The set predicted gate is referred to as a first predicted gate of a relative speed.

As illustrated in FIG. 8, for example, if a predicted value Vrp of a relative speed is calculated in step S80, for the predicted value Vrp of a relative speed, the range of ±ΔVr1 is set as a first predicted gate of a relative speed (hereinafter, also referred to as a first predicted gate Gv1). The first predicted gate Gv1 (i.e., the range of ±ΔVr1) may be set in a predetermined range or, for example, may be variably set depending on an own vehicle speed or the like at the present time.

In contrast, if the process mode is the second tracking process (i.e., a vehicle speed abnormality has occurred), in steps S340, centering on the predicted value of a relative speed calculated in step S80, the association unit 25 sets the range of the observed value of a relative speed which is estimated to be detected from the same target having the predicted value of a relative speed, as a predicted gate. The set predicted gate is referred to as a second predicted gate of a relative speed.

As illustrated in FIG. 8, for example, if a predicted value Vrp of a relative speed is calculated in step S80, for the predicted value Vrp of a relative speed, the range of ±ΔVr2 is set as a second predicted gate of a relative speed (hereinafter, also referred to as a second predicted gate Gv2). The second predicted gate Gv2 (i.e., the range of ±ΔVr2) may be set in a predetermined range or, for example, may be variably set depending on an own vehicle speed or the like at the present time. However, the second predicted gate Gv2 is set to a range wider than that of the first predicted gate.

In succeeding step S350, a degree of contribution (hereinafter, also referred to as a contribution) of elements, which are other than a relative speed (i.e., a distance and an azimuth) among predicted values (i.e., a distance, an azimuth, and a relative speed), to calculation of an association cost is set. For example, αᵣ is set as a contribution of a distance, and α_{β} is set as a contribution of an azimuth. αᵣ and α_{β} are positive values.

Next, in steps S360 to S380, the association unit 25 sets a contribution of a relative speed to be used in calculation of an association cost by a different manner, depending on whether the process mode is the first tracking process, in other words, whether no vehicle speed abnormality has occurred or a vehicle speed abnormality has occurred.

In step S360, the association unit 25 determines whether the process mode is the first tracking process. If determining that the process mode is the first tracking process, the association unit 25 shifts the present process to step S370. If determining that the process mode is the second tracking process, the association unit 25 shifts the present process to step S380.

Here, if the process mode is the first tracking process (i.e., no vehicle speed abnormality has occurred), in steps S370, the association unit 25 sets a first contribution α_{V1} as a contribution of a relative speed.

In contrast, if the process mode is the second tracking process (i.e., a vehicle speed abnormality has occurred), in steps S380, the association unit 25 sets a second contribution α_{V2} as a contribution of a relative speed. The first contribution α_{V1} and the second contribution α_{V2} are positive values, and the second contribution α_{V2} is set to a value smaller than the first contribution α_{V1}. For example, the second contribution α_{V2} may be set to a value sufficiently smaller than the first contribution α_{V1}, for example, a value smaller than 1, such as 1/100, 1/1000, or the like.

In succeeding step S390, the association unit 25 calculates an association cost. The association cost is expressed by, for example, the expression (1). It is noted that each of the observed values and the predicted values is scalar quantity.

$$\begin{matrix}[ Expression 1 ] & \\ Association cost = {α}_{r} * {d}_{a} + {α}_{θ} * {d}_{b} + {α}_{vn} * {d}_{c} & ( 1 )\end{matrix}$$

$$Note that n = 1 in the first tracking process$$

$$n = 2 in the second tracking process$$

Here, dₐ is a difference between a predicted value of a distance and an observed value of a distance, d_{b} is a difference between a predicted value of an azimuth and an observed value of an azimuth, and d_{c} is a difference between a predicted value of a relative speed and an observed value of a relative speed. Here, the difference refers to the magnitude of a difference between scalar quantities (i.e., absolute value). In addition, in a case of the first tracking process, the contribution α_{V1} of a relative speed is used. In a case of the second tracking process, the contribution α_{V2} of a relative speed is used.

The association unit 25 determines the observed value whose calculated association cost is the lowest among the observed values in the predicted gate, as an observed value associated with a predicted value. Then, the association unit 25 terminates the present subroutine.

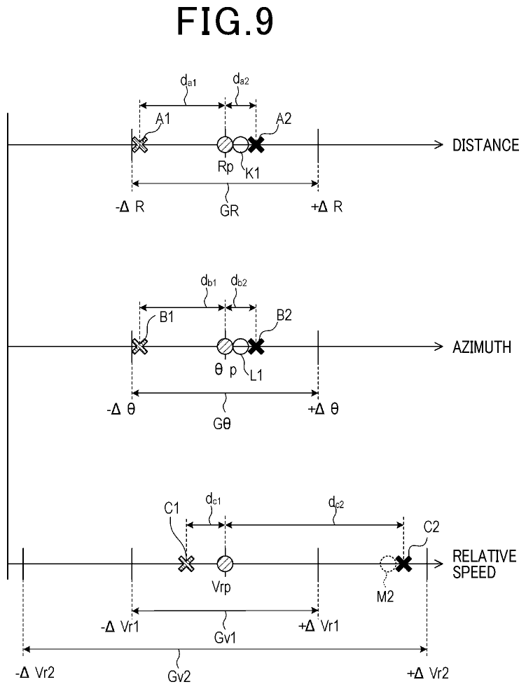

Subsequently, based on FIG. 8 and FIG. 9, operation of the association unit 25 will be described. For example, in FIG. 8, regarding a distance, an observed value A1 and an observed value A2 are detected in the predicted gate GR based on the current predicted value Rp. It is noted that a difference dₐ₁ between the predicted value Rp and the observed value A1>a difference dₐ₂ between the predicted value Rp and the observed value A2. Regarding an azimuth, an observed value B1 and an observed value B2 are detected in the predicted gate Gθ based on the current predicted value θp. It is noted that a difference d_{b1} between the predicted value θp and the observed value B1>a difference d_{b2} between the predicted value θp and the observed value B2.

Regarding a relative speed, observed values C1, C2 are detected in the first predicted gate Gv1 based on the current relative speed Vrp. It is noted that a difference d_{c1} between the predicted value Vrp and the observed value C1>a difference d_{c2} between the predicted value Vrp and the observed value C2.

The observed values A1, B1, C1 are defined as detection values obtained from the same target (e.g., referred to as a first target). The observed values A2, B2, C2 are defined as detection values obtained from the same target (e.g., referred to as a second target) different from the first target. In addition, if no vehicle speed abnormality has occurred, it is assumed that contributions of a distance, an azimuth, and a relative speed to calculation of an association cost are set to be equal (i.e., αᵣ=α_{θ}=α_{V1}).

Here, for example, when no vehicle speed abnormality has occurred, based on the calculated association cost, the observed values A2, B2, C2 of the second target whose association cost is low are determined as observed values associated with the respective current predicted values Rp,θp, Vrp. In contrast, when a vehicle speed abnormality has occurred, in the example of FIG. 8, as in the case in which no vehicle speed abnormality has occurred, based on the calculated association cost, the observed values A2, B2, C2 of the second target whose association cost is low are determined as observed values associated with the respective current predicted values Rp,θp, Vrp.

In contrast, although the example illustrated in FIG. 9 is similar to the example illustrated in FIG. 8 in a distance and an azimuth, regarding a relative speed, the observed value C1 is detected in the first predicted gate Gv1 based on the current relative speed Vrp, and the observed value C2 is not detected in the first predicted gate Gv1. However, the observed value C2 is detected in the second predicted gate Gv2 based on the current relative speed Vrp. That is, when a vehicle speed abnormality has occurred, both of the observed values A1, B1, C1 detected from the first target and the observed values A2, B2, C2 detected from the second target are provided as candidates of observed values respectively associated with the current predicted values Rp, θp, Vrp. It is noted that a difference d_{c1} between the predicted value Vrp and the observed value C1<a difference d_{c2} between the predicted value Vrp and the observed value C2.

Here, for example, when no vehicle speed abnormality has occurred, the observed values A1, B1, C1 of the first target are determined as observed values associated with the respective current predicted values Rp,θp, Vrp, based on the calculated association cost. This is because, in the calculation of the association cost, dₐ₁, dₐ₂, d_{b1}, d_{b2}, d_{c1}, and d_{c2} (i.e., d_{c1}<d_{c2}) make an equal contribution.

In contrast, when a vehicle speed abnormality has occurred, in the example of FIG. 9, regarding a relative speed, an association cost is calculated based on the second association contribution α_{V2} (i.e., 0<α_{V2}<<1). As a result, the observed values A2, B2, C2 of the second target are determined as observed values associated with the respective current predicted values Rp,θp, Vrp. This is because, in the calculation of the association cost, the contributions of d_{c1}, d_{c2} (i.e., d_{c1}<d_{c2}) are greatly reduced, and the contributions of dₐ₁, dₐ₂ (i.e., dₐ₁>dₐ₂) and d_{b1}, d_{b2} (i.e., d_{b1}>d_{b2}) tend to be dominant.

As described above, in the example of FIG. 9, since a contribution to an association cost of a relative speed is reduced when a vehicle speed abnormality has occurred, for elements other than the relative speed, the observed values A2, B2 closer to the predicted values are determined as associated observed values.

When the association process illustrated in FIG. 7 ends, the present process proceeds to step S100 in FIG. 5.

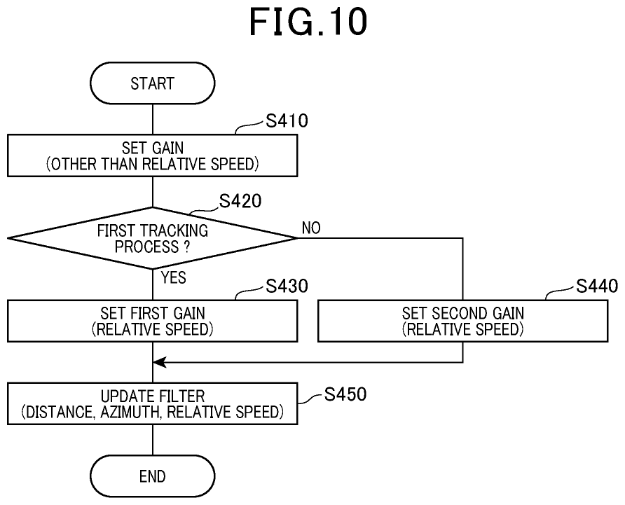

In step S100, the estimation unit 26 calculates an estimated value at the current processing cycle from the predicted value calculated in step S80 and the observed value determined as an associated target in step S90 by, for example, various types of filter processing. An estimated value of a target includes a distance, an azimuth, and a relative speed as elements, as in an observed value and a predicted value. Specifically, the estimation unit 26 executes a subroutine illustrated in FIG. 10 (hereinafter, also referred to as an estimation process).

First, in step S410, regarding elements other than the relative speed, the estimation unit 26 sets a degree (hereinafter, also referred to as a gain) of contribution of an observed value to be used in calculation of an estimated value of the target. The gain is a value smaller than 1. It is noted that a degree of contribution of a predicted value to calculation of an estimated value of the target is calculated as 1−gain. For example, a gain βᵣ is set as a gain of a distance, and a gain β_{θ} is set as a gain of an azimuth. The gain βᵣ and the gain β_{θ} are values smaller than 1.

Next, in steps S420 to S440, regarding the relative speed, the estimation unit 26 sets a gain by a different manner depending on whether the process mode is the first tracking process, in other words, depending on whether no vehicle speed abnormality has occurred or a vehicle speed abnormality has occurred. As described above, the gain indicates a degree of contribution of an observed value to calculation of an estimated value of the target, and is a value smaller than 1.

In step S420, the estimation unit 26 determines whether the process mode is the first tracking process. If determining that the process mode is the first tracking process, the estimation unit 26 shifts the present process to step S430. If determining that the process mode is the second tracking process, the estimation unit 26 shifts the present process to step S440.

Here, if the process mode is the first tracking process (i.e., no vehicle speed abnormality has occurred), in step S430, the estimation unit 26 sets a first gain βᵥ₁ as a gain of the relative speed.

In contrast, if the process mode is the second tracking process (i.e., a vehicle speed abnormality has occurred), in step S440, the estimation unit 26 sets a second gain βᵥ₂ as a gain of the relative speed. The second gain βᵥ₂ is set to a value larger than the first gain βᵥ₁. For example, the second gain βᵥ₂ may be set to a value sufficiently larger than the first gain βᵥ₁ and smaller than 1. Alternatively, the second gain βᵥ₂ may be set to 1.

In succeeding step S450, the estimation unit 26 updates a filter. The filter calculates an estimated value based on the expressions (2) to (4). Updating the filter uses a predicted value and an observed value at the current processing cycle to calculate an estimated value. Specifically, the estimation unit 26 uses gains respectively set in steps S410, S430, and S440 to calculate an estimated value at the current processing cycle based on the expressions (2) to (4).

$$\begin{matrix}[ Expression 2 ] & \\ Estimated value of distance = ( 1 - {β}_{r} ) * Predicted value of distance + {β}_{r} * Observed value of distance & ( 2 )\end{matrix}$$

$$Estimated value of azimuth = ( 1 - {β}_{θ} ) * Predicted value of azimuth + {β}_{θ} * Observed value of azimuth \qquad ( 3 )$$

$$Estimated value of relative speed = ( 1 - {β}_{vn} ) * Predicted value of relative speed + {β}_{vn} * Observed value of relative speed \qquad ( 4 )$$

$$Note that n = 1 in the first tracking process$$

$$n = 2 in the second tracking process$$

If the value of the gain is set to be small, a contribution of an observed value to calculation of an estimated value decreases. If the value of the gain is set to be large, a contribution of an observed value to calculation of an estimated value increases. In other words, since the calculated value of [1−gain] increases as the value of the gain is set to be smaller, a contribution of a predicted value to calculation of an estimated value increases. In contrast, as the value of the gain is set to be larger, a contribution of a predicted value to calculation of an estimated value decreases.

A contribution of a predicted value to calculation of an estimated value based on an observed value and a predicted value is a value obtained by subtract a gain from 1. For example, a contribution of a predicted value of a relative speed to calculation of an estimated value of a relative speed is 1−βᵥ₁ if no vehicle speed abnormality has occurred, and is 1−βᵥ₂ if a vehicle speed abnormality has occurred.

Regarding a relative speed, if a vehicle speed abnormality has occurred, when an estimated value of a target is calculated, a degree of contribution of an observed value to an estimated value is increased (i.e., in other words, such that a degree of contribution of a predicted value is decreased) to set the second gain βᵥ₂. That is, regarding a relative speed, the degree of contribution of a predicted value to an estimated value is higher in a case in which no vehicle speed abnormality has occurred (i.e., (1−βᵥ₁)>(1−βᵥ₂)). Hence, in the present embodiment, as described above, the gain of a relative speed is set as 0<first gain βᵥ₁<<second gain βᵥ₂<1. Alternatively, the second gain βᵥ₂ is set to 1.

For example, in the example of FIG. 8 described above, regarding a distance, an estimated value K1 of a distance is calculated based on the predicted value Rp of a distance and the observed value A2 determined as an observed value of an associated distance. For example, regarding an azimuth, an estimated value L1 of an azimuth is calculated based on the predicted value θp of an azimuth and the observed value B2 determined as an observed value of an associated azimuth.

For example, regarding a relative speed, when no vehicle speed abnormality has occurred, an estimated value M1 of a relative speed is calculated based on the predicted value Vrp of a relative speed and the observed value C2 determined as an observed value of an associated relative speed. When a vehicle speed abnormality has occurred, an estimated value M2 of a relative speed is calculated as a value closer to the observed value C2 based on the predicted value Vrp of a relative speed and the observed value C2 determined as an observed value of an associated relative speed.

In addition, for example, in the example of FIG. 9 described above, when a vehicle speed abnormality has occurred, the estimated value M2 of a relative speed is calculated as a value closer to the observed value C2 based on the predicted value Vrp of a relative speed and the observed value C2 determined as an observed value of an associated relative speed.

It is noted that, in step S450, the estimation unit 26 may calculate an estimated value of a position of a target based on the estimated value K1 of a distance and estimated value L1 of an azimuth determined as described above. In step S450, the estimation unit 26 may calculate a ground speed of a target based on the estimated value M1 or M2 of a relative speed determined as described above and the own vehicle speed acquired in step S20 (i.e., estimated value of ground speed of target=estimated value of relative speed+detected own vehicle speed). The calculated estimated value of the target is stored in the memory 19. Then, the estimation unit 26 terminates the present subroutine.

When the estimation process illustrated in FIG. 10 ends, the present process proceeds to step S70 of an object tracking process illustrated in FIG. 5. Then, while there is unprocessed target information, processing of steps S70 to S100 is repeatedly performed. In contrast, if there is no unprocessed target information, and, in step S70, if the tracking unit 27 determines that there is no unprocessed target information, the present process proceeds to step S110.

In S110, the tracking unit 27 determines whether there is an unused observed value among the observed values detected in step S10. That is, it is determined whether there is an observed value, which is not associated with any predicted value, among the observed values detected in step S10. If determining that there is no unused observed value, the tracking unit 27 terminates the present process. In contrast, if determining that there is an unused observed value, the tracking unit 27 shifts the present process to step S120.

In step S120, the tracking unit 27 registers the unused observed value (i.e., a target from which the unused observed value is detected) as a new target. Thereafter, returning to the processing of step S110, the tracking unit 27 repeatedly performs processing of steps S110 to S120 while there are any unused observed values that have not been subjected to the processing of steps S110 to S120. Then, the tracking unit 27 terminates the present tracking process.

### 2-2. Vehicle Speed Abnormality Detection Process

Next, a vehicle speed abnormality detection process performed in step S30 of the tracking process by the information processing device 3 of the first embodiment will be described with reference to a flowchart of FIG. 11.

First, in step S500, the abnormality detection unit 22 determines whether an acceleration of the own vehicle JV is a predetermined acceleration threshold value or more. In step S20 described above, the abnormality detection unit 22 detects rotational speeds of the respective wheels based on wheel speed signals output from the wheel speed sensors 9 provided to the respective wheels, detects a speed of the own vehicle JV based on the detected rotational speeds of the respective wheels, and stores the detection result in the memory 19.

The abnormality detection unit 22 may calculate, as an acceleration of the own vehicle JV, for example, a difference between an own vehicle speed detected at the current processing cycle and an own vehicle speed detected at the previous processing cycle, based on the own vehicle speed detected in step S20. The acceleration threshold value may be set to be, for example, such a magnitude that can determine whether the own vehicle JV is slipping. For example, the acceleration threshold value may be set to a value smaller than the acceleration of the own vehicle JV that can be measured in a state in which the vehicle is slipped. The acceleration threshold value and the own vehicle speeds detected at the current time and the previous time are stored in the memory 19.

If the acceleration of the own vehicle JV is less than the acceleration threshold value, the abnormality detection unit 22 terminates the present process. If the acceleration of the own vehicle JV is the acceleration threshold value or more, the abnormality detection unit 22 shifts the present process to step S510. It is noted that various threshold values described later are previously stored in the memory 19.

Next, in step S510, the abnormality detection unit 22 determines whether the target number of stationary objects is a predetermined threshold value (hereinafter, also referred to as a stationary object threshold value) or larger. The stationary object threshold value may be set to a predetermined value, such as one to several tens. In the present embodiment, the stationary object threshold value is an integer, and is two or more. For example, the abnormality detection unit 22 determines that a target whose estimated value of a relative speed has a magnitude equal to an own vehicle speed and whose sign is opposite is a stationary object, based on an estimated value of a relative speed of the target at the previous processing cycle. The own vehicle speed is detected in step S20.

Here, if the number of stationary objects (hereinafter, also referred to as the target number) is less than a predetermined threshold value (hereinafter, also referred to as a stationary object threshold value), the abnormality detection unit 22 shifts the present process to step S540. Then, in step S540, the abnormality detection 20) unit 22 determines that the own vehicle speed is normal and terminates the present subroutine. In contrast, if the target number of stationary objects is the stationary object threshold value or more, the abnormality detection unit 22 shifts the present process to step S520. In step S520 and later steps, the abnormality detection unit 22 further calculates prediction residuals of a relative speed of the respective stationary objects to determine whether a vehicle speed abnormality has occurred.

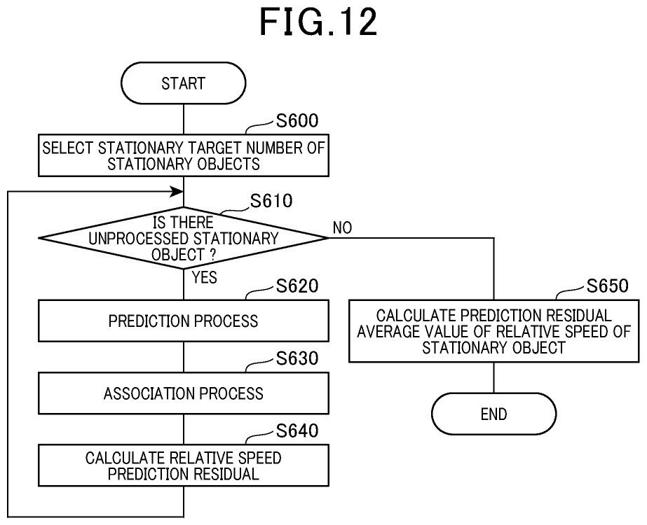

In step S520, regarding the respective stationary objects specified in step S510, the abnormality detection unit 22 calculates prediction residuals of a relative speed. However, the calculation of the prediction residuals of a relative speed in step S520 is not necessarily performed for all the stationary objects detected in step S510. For example, processing in step S520 and later steps may be performed only for stationary objects, the number of which is the stationary target number described later. The prediction residual is a difference between a predicted value and an observed value (i.e., predicted value−observed value). Specifically, the abnormality detection unit 22 executes a subroutine illustrated in FIG. 12 (hereinafter, also referred to as a stationary object prediction residual process).

First, in step S600, the abnormality detection unit 22 selects a predetermined target number (hereinafter, referred to as stationary target number) of stationary objects from among the stationary objects specified in step S510. For example, the stationary object number is the above stationary object threshold value or less and may be set to a value, such as one to several tens. In the present embodiment, the stationary object number is an integer of two or more. Alternatively, the abnormality detection unit 22 may select a stationary target number of stationary objects in order of distances closer to the own vehicle JV from among the stationary objects specified in step S510.

Next, in step S610, the abnormality detection unit 22 determines whether there is an unprocessed stationary object. Specifically, the abnormality detection unit 22 determines whether there is a stationary object for which processing of steps S620 to S640, following step S610, has not been performed among a stationary target number of stationary objects selected in step S600. In step S610, if determining that there is an unprocessed stationary object, the abnormality detection unit 22 selects one stationary object from among unprocessed stationary objects and proceeds to processing of step S620, and performs the processing of steps S620 to S640 regarding a relative speed of the selected stationary object. In contrast, if determining that there is no unprocessed stationary object, the abnormality detection unit 22 shifts the present process to step S650.

In succeeding step S620, the abnormality detection unit 22 selects one stationary object from among the unprocessed stationary objects, and, regarding the stationary object, calculates a predicted value at the current time (e.g., current processing cycle) from the estimated value at the previous processing cycle. For example, the abnormality detection unit 22 calculates a current predicted value as in the first tracking process in step S80 described above.

Next, in step S630, the abnormality detection unit 22 performs association as in the first tracking process of step S90 described above based on the predicted value of a relative speed calculated in step S620, and determines the observed value whose association cost of a relative speed is the lowest among the observed values in the predicted gate, as an observed value of a relative speed associated with the predicted value of a relative speed.

In succeeding step S640, a difference of relative speeds between the observed value determined in step S630 whose association cost is the lowest and the predicted value calculated in step S620 (i.e., absolute value of relative speed predicted value−relative speed observed value) is calculated as a prediction residual of a relative speed regarding the stationary object.

Then, the abnormality detection unit 22 shifts the present process to step S610 and repeats processing of steps S620 to S640 while there are any unprocessed stationary objects. In contrast, if there is no unprocessed stationary object, and it is determined that there is no unprocessed stationary object, the abnormality detection unit 22 shifts the present process to step S650.

In step S650, the abnormality detection unit 22 calculates an average value of prediction residuals of a relative speed of the stationary objects. That is, the abnormality detection unit 22 calculates an average value of a stationary target number of prediction residuals. Hereinafter, the average value of prediction residuals of a relative speed of the stationary objects is also referred to as simply a prediction residual of a relative speed of stationary objects. Then, the abnormality detection unit 22 terminates the present subroutine.

On terminating the subroutine illustrated in FIG. 12, the abnormality detection unit 22 shifts the present process to step S530.

In step S530, the abnormality detection unit 22 determines whether the prediction residual of a relative speed of stationary objects is a predetermined threshold value (hereinafter, also referred to as a prediction residual threshold value) or more. When a target is a stationary object, it can be considered no displacement is generated between a predicted value and an observed value of a relative speed. That is, the predicted residual is considered to be substantially 0. Hence, for example, the prediction residual threshold value may be set to a positive value larger than 0 and close to 0.

Here, if the prediction residual of a relative speed of stationary objects is less than the prediction residual threshold value, the abnormality detection unit 22 shifts the present process to step S540. Then, in step S540, the abnormality detection unit 22 determines that no vehicle speed abnormality has occurred, that is, the detected own vehicle speed is normal, and terminates the present subroutine.

In contrast, if the prediction residual of a relative speed of stationary objects is the prediction residual threshold value or more, the abnormality detection unit 22 shifts the present process to step S550. Then, in step S550, the abnormality detection unit 22 determines that a vehicle speed abnormality has occurred, and terminates the present subroutine. After the present subroutine (i.e., stationary object prediction residual process) is terminated, the 20) present process is shifted to step S40.

### 1-3. Effects

According to the first embodiment described above, the following effects can be obtained.

(1a) If it is determined that no vehicle speed abnormality has occurred, a current estimated value of a target is calculated by the first tracking process that uses a predicted value of a relative speed based on a detection result of an own vehicle speed. In contrast, if it is determined that a vehicle speed abnormality has occurred, a current estimated value of a target is calculated by the second tracking process different from the first tracking process.

Hence, the process can be changed to any of the first tracking process and the second tracking process based on a determination result regarding a vehicle speed abnormality. For example, when the second tracking process is set to a process in which an estimated value of a relative speed is not easily affected by an error in an own vehicle speed, if it is determined that a vehicle speed abnormality has occurred, the second tracking process is performed instead of the first tracking process, whereby the influence of the error in the own vehicle speed can be suppressed when a relative speed is estimated.

As a result, when no vehicle speed abnormality has occurred, tracking of a target (i.e., object) (e.g., calculation of a position of the object, a ground speed of the object, or the like) can be accurately performed while reflecting an own vehicle speed. When a vehicle speed abnormality is detected, accuracy in tracking a target can be suppressed from lowering. It is noted that the tracking of a target refers to repeated acquirement of an estimated value indicating a state of a target (e.g., a position, a ground speed, or the like) in time series (i.e., with a lapse of time), that is, repeated acquirement of a current state based on a past state.

(1b) A predicted gate, which is a range in which it is estimated that a current observed value will be acquired, is set for each calculated current predicted value of an object, based on the predicted value. In addition, based on at least one detected observed value, an observed value associated with a predicted value is determined from among observed values in the predicted gate. Then, a current estimated value of an object is calculated based on the determined observed value and the predicted value. Thus, repeatedly calculating an estimated value based on the observed value and predicted value to acquire estimated values in time series can track a target more accurately compared with a case using only an observed value or a predicted value.

(1c) If it is determined that no vehicle speed abnormality has occurred, a current predicted value of a relative speed is calculated using an own vehicle speed. For example, when the own vehicle JV is accelerated or decelerated at a previous processing cycle and a current processing cycle (i.e., between earlier and later processing cycles), an own vehicle speed to which the acceleration or the deceleration is reflected is detected by the wheel speed sensors 9. Hence, subtracting the detected own vehicle speed from an estimated value of a ground speed of a target can accurately predict a predicted value of a relative speed using the own vehicle speed. Since an accurate predicted value of a relative speed, and furthermore an accurate estimated value of a relative speed, can be acquired, a state of the target such as a position of the target, a ground speed of the target, and the like can be accurately calculated. As a result, when no vehicle speed abnormality has occurred, the target can be accurately tracked.

However, an own vehicle speed is not necessarily accurately detected. For example, if the wheels are slipping, an own vehicle speed may be detected as a value different from an actual speed. Hence, presence or absence of a vehicle speed abnormality (i.e., a likelihood of an own vehicle speed) is determined. If it is determined to be a vehicle speed abnormality (i.e., the own vehicle speed may be not accurate), a current predicted value of a relative speed is calculated without using the own vehicle speed. For example, the same value as the previous estimated value of a relative speed is calculated as a current predicted value of a relative speed. Hence, influence of an error in the own vehicle speed can be reduced in calculation of a predicted value of a relative speed compared with calculation of a predicted value of a relative speed using the own vehicle speed when a vehicle speed abnormality has occurred. As a result, when a vehicle speed abnormality is detected, accuracy in tracking a target can be suppressed from lowering.

(1d) A predicted gate (i.e., second predicted gate Gv2) in a case in which it is determined that a vehicle speed abnormality has occurred is set to be larger (i.e., wider) than a predicted gate (i.e., first predicted gate Gv1) in a case in which it is determined that no vehicle speed abnormality has occurred. Hence, even when a displacement is generated in a predicted value of a relative speed, since a predicted gate is set to be larger, association with an object value of a relative speed can be appropriately performed also in a predicted gate centering on the predicted value of a relative speed in which the displacement is generated. That is, in calculation of an estimated value of a relative speed, influence of an error in an own vehicle speed can be suppressed. As a result, when a vehicle speed abnormality is detected, accuracy in tracking a target can be suppressed from lowering.

(1e) If it is determined that a vehicle speed abnormality has occurred, a contribution of a relative speed to calculation of an association cost, which is an indicator indicating a degree of divergence between a predicted value and an observed value, is lowered compared with a case in which it is determined that no vehicle speed abnormality has occurred. Hence, even when a displacement is generated in a predicted value of a relative speed, an association cost can be calculated mainly based on a predicted value and an observed value of elements other than a relative speed (e.g., a distance, an azimuth) to perform association based on the association cost. As a result, when a vehicle speed abnormality is detected, accuracy in tracking a target can be suppressed from lowering.

(1f) If it is determined that a vehicle speed abnormality has occurred, when an estimated value is calculated regarding a relative speed based on an observed value and a predicted value, a contribution of the predicted value to the estimated value is lowered compared with a case in which it is determined that no vehicle speed abnormality has occurred. Hence, it is determined that the observed value is more probable, whereby influence of a prediction error in the relative speed on the estimated value can be reduced. As a result, when a vehicle speed abnormality is detected, accuracy in tracking a target can be suppressed from lowering.

(1g) Based on the magnitude of an acceleration of the own vehicle JV, if the acceleration is the predetermined acceleration threshold value or more, it is determined that a vehicle speed abnormality has occurred. Hence, a vehicle speed abnormality can be determined by a relatively simple method.

(1h) If a prediction residual of a relative speed of a target is the predetermined prediction residual threshold value or more, it may be determined that a vehicle speed abnormality has occurred. For example, during a short time such as a time period between earlier and later processing cycles, in both a case in which the target is a stationary object and a case in which the target is a dynamic body, it can be considered that the prediction residual of a relative speed of the target is within a predetermined range when no vehicle speed abnormality has occurred. Hence, a vehicle speed abnormality can be detected based on the prediction residual. Specifically in the present embodiment, if an acceleration of the own vehicle JV is the predetermined acceleration threshold value or more, and the prediction residual of a relative speed of the target is the prediction residual threshold value or more, it is determined that a vehicle speed abnormality has occurred. Hence, a vehicle speed abnormality can be accurately determined based on the plurality of conditions.

(1i) Regarding, within targets, a stationary object, if a prediction residual of a relative speed is the prediction residual threshold value or more, it is determined that a vehicle speed abnormality has occurred. For example, when a target is a stationary object, it can be considered that a predicted and an observed value are equal (i.e., the prediction residual is substantially 0). Hence, the prediction residual threshold value may be set to a value close to 0. Since a stationary object is still, and a moving speed thereof does not change, which differs from a dynamic body, using the prediction residual of a relative speed of the stationary object to determine a vehicle speed abnormality can perform an accurate determination compared with a case in which a prediction residual of a relative speed of a dynamic body is used.

(1j) If the number of stationary objects is the stationary object threshold value or larger, at least one stationary object is selected. Then, if the prediction residual of relative speed of the selected stationary object is the prediction residual threshold value or more, it is determined that a vehicle speed abnormality has occurred. For example, when a plurality of stationary objects, the number of which is the stationary target number, are selected, an average value of prediction residuals of a relative speed is calculated regarding the plurality of stationary objects, and the average value of prediction residuals is the prediction residual threshold value or more, it may be determined that a vehicle speed abnormality has occurred. Hence, accuracy in determining a vehicle speed abnormality can be increased compared with a case in which one stationary object is selected to perform the determination based on the prediction residual.

### 1-4. Correspondence Relations Between Wordings

It is noted that the object tracking device 1 corresponds to an object tracking device. The radar device 2 corresponds to a sensor. The information processing device 3 corresponds to an information processing device. The sensor unit 21 corresponds to an observed value detection unit. The abnormality detection unit 22 corresponds to an abnormality determination unit. The prediction unit 24 corresponds to a prediction unit. The association unit 25 corresponds to an association unit. The estimation unit 26 corresponds to an estimation unit. The tracking unit 27 corresponds to a tracking unit. The own vehicle JV corresponds to a vehicle. In addition, the first tracking process (i.e., a process performed when the process mode is the first tracking process) corresponds to a first process. Specifically, steps S230 to S240, S330, S370, and S430 correspond to the first process.

The second tracking process (i.e., a process performed when the process mode is the second tracking process) corresponds to a second process. Specifically, steps S250, S340, S380, and S440 correspond to the second process. Step S10 corresponds to processing performed by the observed value detection unit. Steps S20 to S30 correspond to processing performed by the abnormality determination unit. Step S80 corresponds to processing performed by the prediction unit. Step S90 corresponds to processing performed by the association unit. Step S100 corresponds to processing performed by the estimation unit. Steps S70 to S120 correspond to processing performed by the tracking unit.

The transmission waves and the reflected waves correspond to radar waves. The estimated value of the target at the previous processing cycle corresponds to a past estimated value. The relative speed calculated in step S240 corresponds to a relative speed calculated using an own vehicle speed.

The predicted gate, the first predicted gate, and the second predicted gate correspond a prediction range. The first contribution α_{V1} of a relative speed and the second contribution α_{V2} of a relative speed correspond to a contribution of a relative speed to calculation of an association cost. “1−first gain βᵥ₁” and “1−second gain βᵥ₂” correspond to a contribution of a predicted value of a relative speed to calculation of an estimated value of a relative speed.

### 2. Second Embodiment

### 2-1. Differences from First Embodiment

In the second embodiment, since the basic configuration is similar to that of the first embodiment, differences will be described. It is noted that the same reference sign as that in the first embodiment indicates the same component and refers to the foregoing description.

In the first embodiment described above, when no vehicle speed abnormality has occurred, the prediction unit 24 uses a current detection value of an own vehicle speed to subtract the current detection value of an own vehicle speed from a previous estimated value of a ground speed of a target, thereby calculating a current predicted value of a relative speed. In contrast, the second embodiment differs from the first embodiment in calculating the current predicted value of a relative speed using a difference between a previous detection value of an own vehicle speed and a current detection value of an own vehicle speed.

### 2-2. Process

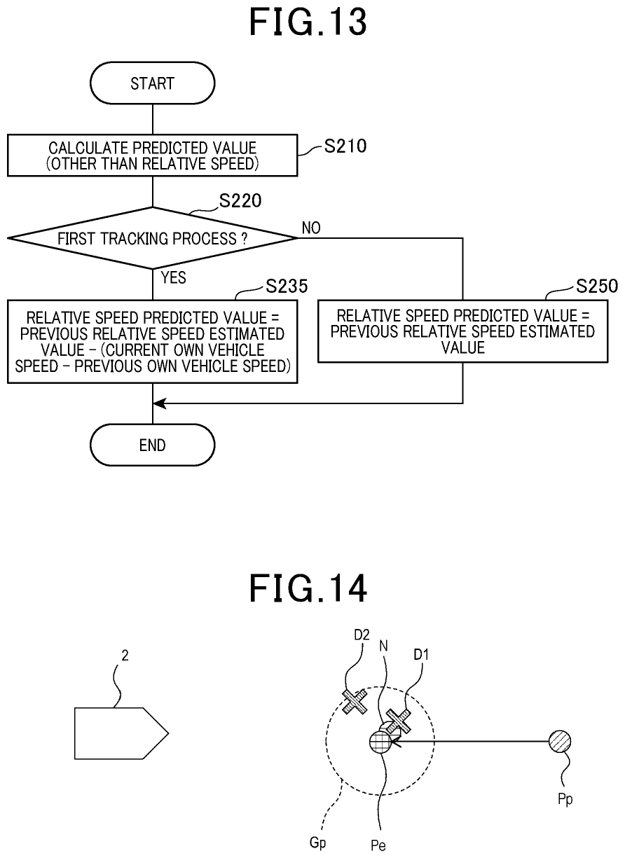

Next, a process performed by the information processing device 3 of the second embodiment instead of the prediction process of the first embodiment (i.e., FIG. 6) will be described with reference to a flowchart of FIG. 13. It is noted that since processing of steps S210 to S220 and S250 in FIG. 13 is similar to that of FIG. 6, the description thereof is partially simplified.

In step S235 to which the present process proceeds if it is determined to be the first tracking process (i.e., no vehicle speed abnormality has occurred) in step S220, the prediction unit 24 calculates a predicted value of a relative speed. The prediction unit 24 calculates a difference between the own vehicle speed acquired in step S20 at the current processing cycle and the own vehicle speed acquired in step S20 at the previous processing cycle (i.e., current own vehicle speed−previous own vehicle speed). That is, a difference between the own vehicle speeds between earlier and later processing cycles (i.e., in other words, a speed variation of the own vehicle JV between earlier and later processing cycles) is calculated. The prediction unit 24 calculates, as a current predicted value of a relative speed, a value obtained by subtracting the speed variation of the own vehicle JV between earlier and later processing cycles from a current predicted value of a relative speed. Then, the prediction unit 24 terminates the subroutine of the prediction process.

### 2-3. Effects

According to the second embodiment described above in detail, in addition to the effects (1a) to (1j) of the first embodiment described above, the following effects can be obtained.

(2a) As a current predicted value of a relative speed, a value obtained by subtracting a speed variation of the own vehicle JV between earlier and later processing cycles from a previous estimated value of a relative speed is calculated. Hence, when acceleration or deceleration of the own vehicle JV is detected based on the change of an own vehicle speed, a relative speed can be accurately predicted by reflecting the acceleration or the deceleration (i.e., speed variation) to the relative speed. For example, when the own vehicle JV is accelerating, as a predicted value of a relative speed, a value is calculated by decreasing the previous estimated value of a relative speed by the magnitude of the acceleration. When the own vehicle JV is decelerating, as a predicted value of a relative speed, a value is calculated by increasing the previous estimated value of a relative speed by the magnitude of the deceleration.

Since an accurate predicted value of a relative speed, and furthermore an accurate estimated value of a relative speed, can be acquired, a state of an object such as a position of the object, a ground speed of the object, or the like can be accurately calculated. As a result, as in (1c) described above, when no vehicle speed abnormality has occurred, the target can be accurately tracked.

It is noted that, in the embodiment described above, step S235 corresponds to a first process, and the relative speed calculated in step S235 corresponds to a relative speed calculated using an own vehicle speed.

### 3. Other Embodiments

Embodiments of the present disclosure have been described above. However, the present disclosure is not limited to the above embodiments and can be variously modified.

(3a) In the information processing device 3 described in the present disclosure, the abnormality detection unit 22 uses an average value of prediction residuals of a relative speed regarding a plurality of stationary objects to determine whether a vehicle speed abnormality has occurred. However, the present disclosure is not limited to this. For example, it may be determined whether a vehicle speed abnormality has occurred using a prediction residual of a relative speed regarding one stationary object. For example, one stationary object closest to the own vehicle JV may be selected, and a prediction residual of the stationary object may be used to determine whether a vehicle speed abnormality has occurred. In this case, in the process of FIG. 11, for example, steps S510 to S520 may be omitted.

(3b) In the information processing device 3 described in the present disclosure, the association cost indicates that as a value of the association cost is smaller, a relationship between a predicted value and an observed value is higher, and that as the value of the association cost is larger, the relationship between a predicted value and an observed value is lower. However, the present disclosure is not limited to this. For example, the association cost may indicate that as a value of the association cost is larger, a relationship between a predicted value and an observed value is higher, and that as the value of the association cost is smaller, the relationship between a predicted value and an observed value is lower. In this case, for example, instead of the difference between a predicted value and an observed value, the inverse of the difference between a predicted value and an observed value may be used to calculate the association cost. As in the information processing device 3 described above, the second association contribution α_{V2} of a relative speed may be set to a value smaller than 1 and sufficiently lower than the first association contribution α_{V1} of a relative speed.

(3c) In the information processing device 3 described in the present disclosure, the prediction unit 24 may be configured to calculate a relative speed with respect to the own vehicle JV always using an own vehicle speed regardless of presence or absence of a vehicle speed abnormality. That is, the prediction unit 24 may be configured by omitting processing of steps S220 and S250. In this case, in at least one of setting of a predicted gate by the association unit 25, setting of an association contribution by the association unit 25, and setting of a gain by the estimation unit 26, the process whose process mode is set to the second tracking process when a vehicle speed abnormality has occurred (i.e., steps S340, S380, S440) may be performed. Hence, when a vehicle speed abnormality is detected, since influence of a detection error in an own vehicle speed is reduced in the tracking process, as a result, accuracy in tracking a target can be suppressed from lowering.

(3d) Similarly, in the information processing device 3 described in the present disclosure, the association unit 25 may be configured to set a predicted gate by the same manner regardless of presence or absence of a vehicle speed abnormality. That is, the association unit may be configured by omitting processing of steps S320 and S340. In this case, in at least one of calculation of a predicted value of a relative speed by the prediction unit 24, setting of an association contribution by the association unit 25, and setting of a gain by the estimation unit 26, the process whose process mode is set to the second tracking process when a vehicle speed abnormality has occurred (i.e., steps S250, S380, S440) may be performed.

(3e) Similarly, in the information processing device 3 described in the present disclosure, the association unit 25 may be configured to set an association contribution by the same manner regardless of presence or absence of a vehicle speed abnormality. That is, the association unit 25 may be configured by omitting processing of steps S360 and S380. In this case, in at least one of calculation of a predicted value of a relative speed by the prediction unit 24, setting of a predicted gate by the association unit 25, and setting of a gain by the estimation unit 26, the process whose process mode is set to the second tracking process when a vehicle speed abnormality has occurred (i.e., steps S250, S340, S440) may be performed.

(3f) Similarly, in the information processing device 3 described in the present disclosure, the estimation unit 26 may be configured to set a gain by the same manner regardless of presence or absence of a vehicle speed abnormality. That is, the estimation unit 26 may be configured by omitting processing of steps S420 and S430. In this case, in at least one of calculation of a predicted value of a relative 20) speed by the prediction unit 24, setting of a predicted gate by the association unit 25, and setting of an association contribution by the association unit 25, the process whose process mode is set to the second tracking process when a vehicle speed abnormality has occurred (i.e., steps S250, S340, S380) may be performed.

(3g) In the information processing device 3 described in the present disclosure, an estimated value for indicating a state of a target includes elements, which are at least a distance, an azimuth, and a relative speed. However, the elements included in the estimated value are not limited to these. For example, the estimated value may include a position of an object as an element. Specifically, the estimated value may include an x-axis coordinate value Cx and a y-axis coordinate value Cy as elements. The x-axis is an axis along the width direction of the own vehicle JV. The y-axis is an axis that is orthogonal to the x-axis and is along the longitudinal direction of the own vehicle JV. Regarding each of these, a predicted value, an observed value, and an estimated value may be calculated.

In this case, for example, as illustrated in FIG. 14, first, regarding a position of an object, a predicted value Pp at the current processing cycle is calculated from an estimated value Pe at the previous processing cycle. Next, of observed values of a position of the object observed by the radar device 2, observed values D1, D2 in a predicted gate Gp regarding a position set centering on the predicted value Pp are detected as observed values that are likely to be associated with the predicted value Pp.

Here, assuming that a distance between the predicted value Pp and the observed value is used as an association cost without change, the observed value D1 is determined as an observed value associated with the predicted value Pp. Then, using the associated observed value D1 and predicted value Pp, an estimated value N of a position at the current processing cycle is calculated based on a gain regarding the position.

It is noted that, in the information processing device 3 described in the present disclosure, an estimated value may have the same element as that of an observed value or a predicted value or may have an element different from those of an observed value and a predicted value.

(3h) The information processing device 3 and the processing thereof described in the present disclosure may be implemented by a dedicated computer which is provided by configuring a processor and a memory that are programmed to execute one or more functions embodied by a computer program. Alternatively, the information processing device 3 and the processing thereof described in the present disclosure may be implemented by a dedicated computer which is provided by configuring a processor with one or more dedicated hardware logic circuits.

Alternatively, the information processing device 3 and the processing thereof described in the present disclosure may be implemented by one or more dedicated computers which are configured by combining a processor and a memory that are programmed to execute one or more functions, with a processor that is configured by one or more hardware logic circuits.

Furthermore, the computer program may be stored in a computer readable non-transitory tangible storage medium, as instructions to be executed by the computer. The method implementing functions of parts included in the information processing device 3 may not necessarily include software. All the functions may be implemented by one or a plurality of hardware components.

(3i) The information processing device 3 described in the present disclosure may be configured on one chip.

(3j) A plurality of functions of a single component of the above embodiments may be implemented by a plurality of components. One function of one component may be implemented by a plurality of components. A plurality of functions of a plurality of components may be implemented by a single component. One function implemented by a plurality of components may be implemented by a single component. Furthermore, part of the configuration of the above embodiments may be omitted. Furthermore, at least part of the configuration of the above embodiments may be added to or replaced 20 by another part of the configuration of the embodiments.

(3k) The present disclosure may be implemented by, in addition to the information processing device 3 described above, various forms such as the CPU 11 of the information processing device 3, the object tracking device 1 including the information processing device 3 as an element, a program for causing the information processing device 3 to function, a program for causing the CPU 11 of the information processing device 3 to function, a non-transitory tangible storage medium such as a semiconductor memory storing the program, and a tracking method implemented by the program. In addition, for example, the present disclosure may be implemented by various forms such as a method implemented by the information processing device 3, a method implemented by the CPU 11 of the information processing device 3, and a tracking method of the object tracking device 1.

An aspect of the present disclosure provides an information processing device (3) for a vehicle, the device including: an observed value detection unit (21) configured to acquire an observation signal output from a sensor (2) transmitting and receiving radar waves and detect, from the observation signal, at least one observed value related to at least one target around the vehicle; a tracking unit (27) configured to track the target by calculating a current predicted value from a past estimated value which indicates a state of the target and calculating a current estimated value from a current observed value and the current predicted value at predetermined processing cycles; and an abnormality determination unit (22) configured to determine whether a vehicle speed abnormality has occurred. If it is determined that no vehicle speed abnormality has occurred, the tracking unit performs a first process using the predicted value of a relative speed based on a detection result of a vehicle speed to calculate the current estimated value. If it is determined that the vehicle speed abnormality has occurred, the tracking unit performs a second process different from the first process to calculate the current estimated value.

According to the present disclosure, the process is changed to any of the first process (i.e., a process that can acquire an accurate predicted value of a relative speed, and furthermore an accurate estimated value of a relative speed, based of a detection result of a vehicle speed) and the second process (i.e., a process different from the first process) based on a determination result regarding a vehicle speed abnormality. Hence, when the second process is set to a process in which the estimated value of a relative speed is not easily affected by an error in a vehicle speed, if it is determined that a vehicle speed abnormality has occurred, the second process is performed instead of the first process, whereby the influence of the error in the vehicle speed can be suppressed when a relative speed is estimated.

As a result, when no vehicle speed abnormality has occurred, an object can be accurately tracked. when a vehicle speed abnormality has been detected, accuracy in tracking a target (i.e., the object) can be suppressed from lowering.

It is noted that the above information processing device may be provided as an object tracking device including a radar device. According to the object tracking device, similar effects can be obtained. In addition, the procedure performed by the above information processing device may be provide as a tracking method. According to the tracking method, the similar effects can be obtained. In addition, a program for causing a computer to function as the above information processing device may be configured. Operating the computer according to the program can obtain the similar effects.

What is claimed is:

1. An information processing device for a vehicle, the device comprising:
an observed value detection unit configured to acquire an observation signal output from a sensor transmitting and receiving radar waves and detect, from the observation signal, at least one observed value related to at least one target around the vehicle;
a tracking unit configured to track the target by calculating a current predicted value from a past estimated value which indicates a state of the target and calculating a current estimated value from a current observed value and the current predicted value at predetermined processing cycles; and
an abnormality determination unit configured to determine whether a vehicle speed abnormality has occurred, wherein
if it is determined that no vehicle speed abnormality has occurred, the tracking unit performs a first process using the predicted value of a relative speed based on a detection result of a vehicle speed to calculate the current estimated value, and
if it is determined that the vehicle speed abnormality has occurred, the tracking unit performs a second process different from the first process to calculate the current estimated value.

2. The information processing device according to claim 1, wherein
the tracking unit includes:
a prediction unit configured to calculate the current predicted value from the past estimated value;
an association unit configured to, based on the predicted value, set a prediction range in which it is estimated that the current observed value will be acquired, determine an observed value, which is in the prediction range and is associated with the predicted value, from the detected at least one observed value, and determine the observed value associated with the calculated predicted value; and
an estimation unit configured to calculate the current estimated value of the target based on the determined observed value and predicted value.

3. The information processing device according to claim 2, wherein
if it is determined that no vehicle speed abnormality has occurred, the prediction unit calculates, in the first process, the current predicted value of a relative speed using the vehicle speed, and
if it is determined that the vehicle speed abnormality has occurred, the prediction unit calculates, in the second process, the predicted value of a relative speed without using the vehicle speed.

4. The information processing device according to claim 2, wherein
in the second process which is for a case in which it is determined that the vehicle speed abnormality has occurred, the association unit sets the prediction range to be larger than in the first process which is for a case in which it is determined that no vehicle speed abnormality has occurred.

5. The information processing device according to claim 2, wherein
in the second process which is for a case in which it is determined that the vehicle speed abnormality has occurred, the association unit sets a contribution of the relative speed to be used in calculation of an association cost, which is an indicator indicating a degree of divergence between the predicted value and the observed value, to be lower than in the first process which is for a case in which it is determined that no vehicle speed abnormality has occurred.

6. The information processing device according to claim 2, wherein
in the second process in a case in which it is determined that the vehicle speed abnormality has occurred, the estimation unit sets a contribution of the predicted value of the relative speed to be used in calculation of the estimated value of the relative speed to be lower than in the first process in a case in which it is determined that no vehicle speed abnormality has occurred.

7. The information processing device according to claim 1, wherein
based on a magnitude of an acceleration of the vehicle, the abnormality determination unit determines that the vehicle speed abnormality has occurred if the acceleration is a predetermined acceleration threshold value or more.

8. The information processing device according to claim 1, wherein
the abnormality determination unit determines that the vehicle speed abnormality has occurred if a prediction residual, which is a difference between the predicted value and the observed value, related to the relative speed is a predetermined prediction residual threshold value or more.

9. The information processing device according to claim 8, wherein
the abnormality determination unit determines that the vehicle speed abnormality has occurred if the prediction residual related to the relative speed of a stationary object of the at least one target is the predetermined prediction residual threshold value or more.

10. The information processing device according to claim 9, wherein
if the number of stationary objects is the predetermined stationary target number or more, the abnormality determination unit determines that the vehicle speed abnormality has occurred if the prediction residual related to the relative speed of at least one of the stationary objects is the predetermined prediction residual threshold value or more.

11. An object tracking device for a vehicle, the device comprising:
a sensor transmitting and receiving radar waves;
an observed value detection unit configured to acquire an observation signal output from the sensor and detect, from the observation signal, at least one observed value related to at least one target around the vehicle;
a tracking unit configured to track the target by calculating a current predicted value from a past estimated value which indicates a state of the target and calculating a current estimated value from a current observed value and the current predicted value at predetermined processing cycles; and
an abnormality determination unit configured to determine whether a vehicle speed abnormality has occurred, wherein
if it is determined that no vehicle speed abnormality has occurred, the tracking unit performs a first process using the predicted value of a relative speed based on a detection result of a vehicle speed to calculate the current estimated value, and
if it is determined that the vehicle speed abnormality has occurred, the tracking unit performs a second process different from the first process to calculate the current estimated value.

12. A tracking method for an information processing device for a vehicle, the method comprising:
acquiring an observation signal output from a sensor transmitting and receiving radar waves and detecting, from the observation signal, at least one observed value related to at least one target around the vehicle;
tracking the target by calculating a current predicted value from a past estimated value which indicates a state of the target and calculating a current estimated value from a current observed value and the current predicted value at predetermined processing cycles; and
determining whether a vehicle speed abnormality has occurred, wherein
if it is determined that no vehicle speed abnormality has occurred, a first process is performed using the predicted value of a relative speed based on a detection result of a vehicle speed to calculate the current estimated value, and
if it is determined that the vehicle speed abnormality has occurred, a second process different from the first process is performed to calculate the current estimated value.

13. A storage medium in which a program is stored to cause a computer, which configures an information processing device for a vehicle, to function as an observed value detection unit configured to acquire an observation signal output from a sensor transmitting and receiving radar waves and detect, from the observation signal, at least one observed value related to at least one target around the vehicle; a tracking unit configured to track the target by calculating a current predicted value from a past estimated value which indicates a state of the target and calculating a current estimated value from a current observed value and the current predicted value at predetermined processing cycles; and an abnormality determination unit configured to determine whether a vehicle speed abnormality has occurred, wherein
if it is determined that no vehicle speed abnormality has occurred, the tracking unit performs a first process using the predicted value of a relative speed based on a detection result of a vehicle speed to calculate the current estimated value, and
if it is determined that the vehicle speed abnormality has occurred, the tracking unit performs a second process different from the first process to calculate the current estimated value.
